(19) United States
(12) Patent Application Publication
(10) Pub. No.: US 2026/0348730 A1
(43) Pub. Date: Nov. 5, 2026

(54) DETECTION AND CORRECTION OF DRIFT IN A STAR TRACKING NAVIGATION DEVICE

(71) Applicant: SAFRAN ELECTRONICS & DEFENSE, Paris (FR)

(72) Inventors: Guillaume Pierre RANCE, Moissy-Cramayel (FR); Philippe ELIE, Moissy-Cramayel (FR)

(73) Assignee: SAFRAN ELECTRONICS & DEFENSE, Paris (FR)

(21) Appl. No.: 19/123,538

(22) PCT Filed: Oct. 24, 2023
(86) PCT No.: PCT/FR2023/051667

§ 371 Date: Apr. 23, 2025

(30) Foreign Application Priority Data
Oct. 24, 2022 (FR) 2210995

(51) Int. Cl. G01C 21/20

(52) U.S. Cl. CPC G01C 21/203

(57) ABSTRACT

A method for correcting drift in a navigation device for a vehicle using a star tracking geolocation means, the method including: a step of preselecting observable stars to be used; then a step of measurements including the navigation device determining the geographical coordinates of the tracker and then, for each of the selected stars, checking the accessibility of the star and measuring the horizontal coordinates; then a processing step including, for all of the stars for which measured horizontal coordinates have been recorded, calculating the geographical coordinates of the star tracker, and estimating the error between the calculated geographical coordinates and the geographical coordinates determined by the navigation device during the tracking of the star; then a step of estimating the drift error in the navigation device; and a step of correcting the drift in the navigation device.

### TECHNICAL FIELD

The invention relates to the geolocation of surface vessels having a navigation system on board, and more particularly to a system and method for detecting and correcting errors in a geolocation system on board a surface vessel, in particular when it is moving in the open sea.

### PRIOR ART

A navigation system is a system of inertial sensors providing an estimate of the position and altitude of the carrier on the Earth. The main advantage of a navigation system is that it is autonomous, in other words that its position estimate does not depend on any other external system. However, its main disadvantage is that the position estimate gradually deteriorates over time, by a few kilometres per day. The position estimate is said to drift over time.

In order to estimate this position error, it is necessary to have a reliable external source of information from time to time. In general, the external reference used is a satellite positioning system, because of its precision and availability. These global navigation satellite systems are known by the acronym GNSS for Global Navigation Satellite Systems. The best-known example of GNSS is the American GPS system (Global Positioning System). However, it is possible for the GNSS to be inaccessible or for decoy GNSS data to be received: in this case, the positioning system of the vessel may fail and, in the case of a combat vessel, the combat system may fail.

There are several solutions for finding the position of a vessel with no GNSS reference available.

The first known solution requires a georeferenced landmark, in other words a fixed, unambiguously identifiable landmark such as a lighthouse, for example. This solution is precise, but only applicable in specific circumstances in the presence of a landmark in coastal navigation using, for example, the Breton sailor's almanac (L'almanach du marin Breton, 2022).

The second known solution requires ephemerides of the sun, a timepiece and a sextant. This solution is not very accurate (of order 3 nautical miles), and is only applicable when the sun is visible and at its zenith. The principle of estimating position by measuring with a sextant is explained, for example, in Umland's 2019 document entitled “A Short Guide to Celestial Navigation”.

The third known solution requires star ephemerides, a timepiece, a precise tracking system and an inclinometer (a system of accelerometers giving the vertical of the location). This is known as stellar navigation. The principle of this method is described, for example, in (Wei, Cui, Wang, & Wan, 2019). The tracking error compensation uses the QUEST (QUaternion ESTimator) method. However, there is no guarantee on the precision of the position estimator.

Using the stars to find your position on Earth is well known. However, existing methods can be imprecise because the methods for discriminating the stars to be observed are not sufficiently developed. More specifically, some star trackers return unreliable location accuracies; either because they are located in singular regions of space, i.e. intrinsically unobservable, or because they are in regions of space where they will amplify the defects of the tracker.

### DISCLOSURE OF THE INVENTION

The aim of the invention is to overcome the above-mentioned disadvantages and to provide a solution for rapid detection of this type of drift in a navigation device, at sea for example, or for finding one's position in the absence of a signal from the navigation device.

The present invention also makes it possible to identify regions of space that are unfavourable for stellar tracking geolocation, as well as regions that are more favourable for geolocation and less prone to tracking errors.

This aim is achieved through a method for selecting observable stars to use for a geolocation by a vehicle, in particular a vessel at sea, from a star tracking geolocation means associated with at least one navigation device, the stars being selected from stars listed in a catalogue where each star is associated with equatorial coordinates on a specific date, the equatorial coordinates comprising a right ascension, α, and a declination, δ.

The method comprises determining the geographical coordinates of a star tracker at a start time by the navigation device, the geographical coordinates of the star tracker comprising a longitude, L, and a latitude, ¢.

Then, it comprises, for each star of the catalogue, calculating the tracking coordinates of the star, determining the accessibility of the star from the calculated tracking coordinates, and, if the star is accessible, calculating an observation sensitivity parameter of the star, the tracking coordinates of the star corresponding to the horizontal coordinates of the star relative to the geographical position of the star tracker, the horizontal coordinates comprising an azimuth, A, and an elevation, h, then storing the tracking coordinates and observation sensitivity parameter calculated for each star, and classifying stars thus stored in ascending order of sensitivity parameter of the star, the stars for which the sensitivity parameter is zero being excluded from the classification, and selecting a given number of observable stars, the stars being selected according to the order of classification of the stored stars.

According to a first embodiment of the invention of the selection method, calculating the tracking coordinates of each star may comprise calculating the horizontal coordinates of the star from equatorial coordinates of the star and the geographical position of the tracker, the equatorial coordinates comprising an azimuth, A, of the star and an elevation, h, of the star, and determining of the accessibility of the star may comprise comparing the calculated elevation for the star to a minimum elevation threshold, the star being inaccessible if its calculated elevation is less than the minimum elevation threshold.

Preferably, the geographical coordinates of the tracker used for calculating the horizontal coordinates of the star depend on the time at which the calculation is performed, the geographical coordinates of the tracker being estimated at each time from geographical coordinates of the tracker determined at the start time and a calculation taking account of the heading and speed of the vehicle at the time of the determination.

In a second embodiment of the selection method, the calculation of the tracking coordinates of the star from geographical coordinates of the star tracker and the equatorial coordinates of the star considered can be performed using the system of equations (S):

$$S = \{ \begin{matrix}H = LAST - α = GAST + L - α \\ sin ( h ) = sin ( ϕ ) sin ( δ ) + cos ( ϕ ) cos ( δ ) cos ( H ) \\ cos ( A ) cos ( h ) = - cos ( H ) sin ( ϕ ) cos ( δ ) + sin ( δ ) cos ( ϕ ) \\ sin ( A ) cos ( h ) = - sin ( H ) cos ( δ ) \\ tan ( A ) = \frac{sin ( H )}{cos ( H ) sin ( ϕ ) - tan ( δ ) cos ( ϕ )}\end{matrix} \qquad [ Math 1 ]$$

With GAST designating the Greenwich apparent sidereal time and LAST designating the local apparent sidereal time.

In a third embodiment of the selection method, the calculated observation sensitivity parameter, Xᵢ, of the star, Stᵢ, preferably depends solely on the azimuth, A, elevation, h, and declination, δ, of the star considered.

In a fourth embodiment of the selection method, the observation sensitivity parameter, Xᵢ, of the star, Stᵢ, is calculated by means of the equation:

$${X}_{i} := {( \frac{{l}_{1}}{{Δ}_{L}} )}^{2} + {( \frac{{l}_{2}}{{Δ}_{L}} )}^{2} + {( \frac{{p}_{1}}{{Δ}_{ϕ}} )}^{2} + {( \frac{{p}_{1}}{{Δ}_{ϕ}} )}^{2} \qquad [ Math 2 ]$$

$$with {l}_{1} = cos ( A ) cos ( h ) , {l}_{2} = - sin ( A ) sin ( h ) , \\ {Δ}_{L} = \sqrt{{cos ( δ )}^{2} - {sin ( A )}^{2} {cos ( h )}^{2}} , \qquad [ Math 3 ]$$

$${p}_{1} = cos ( h ) sin ( A ) ( ( {sin ( h )}^{2} - {cos ( h )}^{2} {cos ( A )}^{2} ) sin ( δ ) \sqrt{{cos ( δ )}^{2} - {sin ( A )}^{2} {cos ( h )}^{2}} - cos ( h ) sin ( h ) cos ( A ) ( {cos ( δ )}^{2} - {sin ( A )}^{2} {cos ( h )}^{2} - {sin ( δ )}^{2} ) ) , \qquad [ Math 4 ]$$

$${p}_{2} = ( 1 + {sin ( A )}^{2} {cos ( h )}^{2} ) sin ( h ) cos ( A ) sin ( δ ) \sqrt{{cos ( δ )}^{2} - {sin ( A )}^{2} {cos ( h )}^{2}} - cos ( h ) ( {sin ( δ )}^{2} {sin ( A )}^{2} {sin ( h )}^{2} + {cos ( A )}^{2} ( {cos ( δ )}^{2} - {sin ( A )}^{2} {cos ( h )}^{2} ) ) , and \qquad [ Math 5 ]$$

$${Δ}_{ϕ} = \sqrt{{cos ( δ )}^{2} - {sin ( A )}^{2} {cos ( h )}^{2}} ( 1 - {sin ( A )}^{2} {cos ( h )}^{2} ) \vert cos ( A ) cos ( h ) \sqrt{{cos ( δ )}^{2} - {sin ( A )}^{2} {cos ( h )}^{2}} - sin ( δ ) sin ( h ) \vert , \qquad [ Math 6 ]$$

$$with h ∈ [ 0 , \frac{π}{2} ] , A ∈ [ 0 , 2 π ] , δ ∈ [ - \frac{π}{2} , \frac{π}{2} ] and H ∈ [ - \frac{π}{2} , \frac{π}{2} ] .$$

The aim of the invention is achieved in a second stage by means of a method for correcting drift in a navigation device for a vehicle using a star tracking geolocation means.

The correction method comprises a step of preselecting stars comprising a selection of stars to be used by the star tracking geolocation device, using the method for selecting observable stars to be used, as defined above.

Then, the method comprises a step of measurements comprising, firstly, the navigation device determining the geographical coordinates of the star tracker, the geographical coordinates of the star tracker comprising a longitude (L) and a latitude (φ), then, for each of the selected stars, checking the accessibility of the star and measuring the horizontal coordinates of the star, the measured horizontal coordinates being recorded in association with the corresponding equatorial coordinates for the star and the time of measurement, then a processing step comprising, for all the stars for which the measured horizontal coordinates have been recorded, calculating the geographical coordinates of the star tracker from measured horizontal coordinates recorded for the star, the recorded time of measurement, recorded equatorial coordinates and the system of equations (S) defined above according to [Math 1], estimating the error between the calculated geographical coordinates and the geographical coordinates determined by the navigation device during the tracking of the star, then a step of estimating the drift error in the navigation device from estimated errors in the geographical coordinates, and a step of correcting the drift in the navigation device using the estimated drift error.

In an embodiment of the correction method, the measurements step comprises calculating the horizontal coordinates of the selected star from the time of calculation, the geographical coordinates of the star tracker at the time of calculation, and the equatorial coordinates indicated in a catalogue where each star is associated with equatorial coordinates on a specific date called, for example, J 2000, the equatorial coordinates comprising a right ascension (α) and a declination (δ) and the horizontal coordinates comprising an azimuth (A) and an elevation (h), then an orienting a star tracker according to the calculated horizontal coordinates, checking the accessibility of the selected star, if the selected star is inaccessible, repeating the three preceding steps with a new star from the selection of stars, if the star is accessible, repositioning the selected star at the centre of the star tracker, the navigation device measuring the horizontal coordinates of the star tracked by the star tracker after repositioning, and recording the time of measurement of the recalculated horizontal coordinates thus measured, the associated equatorial coordinates and the geographical coordinates of the tracker at the time of measurement.

The measurement by the navigation device of the horizontal coordinates of the star tracked by the star tracker after repositioning is preferably carried out during 5 seconds.

Advantageously, the navigation device may comprise a satellite positioning system.

Advantageously, the navigation device may comprise an inertial unit.

### BRIEF DESCRIPTION OF THE DRAWINGS

FIG. 1 is a schematic representation of the geographical coordinate system as defined in the geocentric prior art.

FIG. 2 is a schematic representation of the equatorial coordinate system as defined in the geocentric prior art.

FIG. 3 is a schematic representation of the horizontal coordinate system as defined in the geocentric prior art.

FIG. 4 schematically represents the link between the three different coordinate systems of FIGS. 1 to 3 and the local apparent sidereal time LAST.

FIG. 5 schematically illustrates a star tracker architecture on a surface vessel.

FIG. 6 graphically represents a categorisation of observation locations according to an embodiment of the invention.

FIG. 7 is a flow diagram of a method for selecting stars according to an embodiment of the invention.

FIG. 8 is a flow diagram of a method for correcting the drift in a navigation device according to an embodiment of the invention.

### DESCRIPTION OF THE EMBODIMENTS

Navigating using the stars involves working with three different coordinate systems: geographic coordinates, equatorial coordinates and horizontal coordinates.

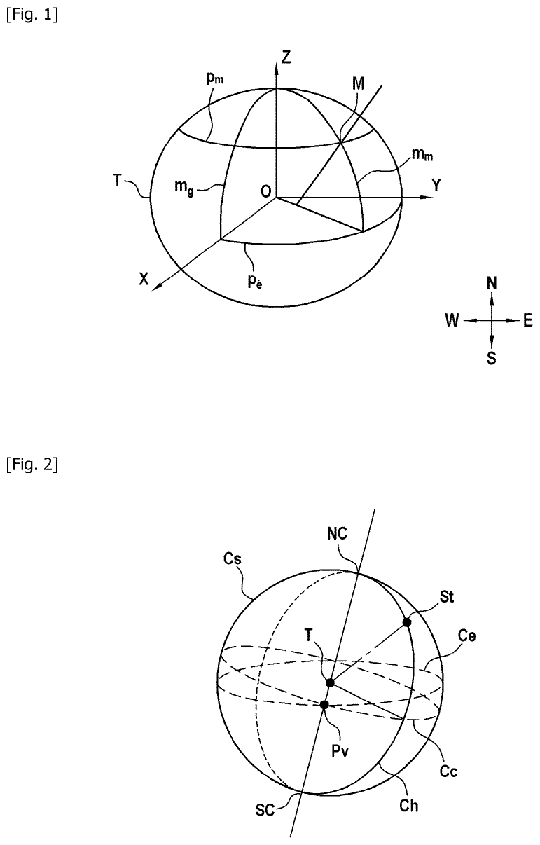

As illustrated in FIG. 1, the geographical coordinates comprise longitude L and latitude φ.

They enable a point on the Earth's surface T to be located, the Earth's surface being assimilated to a geoid with centre O. The figure shows an x, y and z trihedron intersecting at the centre O of the Earth's geoid T. Longitude L is an angle measured in relation to the centre O of the geoid. Longitude is a first angle which has as its point of origin the Greenwich meridian m_{g} and is counted positively when turning around the z axis towards the East, E, and negatively towards the West, W. Latitude φ is a second angle measured in relation to the equator pe and is counted positively when turning around the y axis towards the North Pole, N, and negatively towards the South Pole, S.

A point M on the Earth's geoid T has a longitude L corresponding to the angle between the Greenwich meridian m_{g} and the meridian mₘ of M, and a latitude φ corresponding to the angle between the equator p_{é} and the parallel pₘ at the equator passing through M.

As illustrated in FIG. 2, the equatorial coordinates comprise the right ascension α and the declination δ.

This time, the Earth T is at the centre of a celestial sphere Cs over which an hour circle Ch passes, passing through the celestial north pole NC and the celestial south pole SC. The representation also includes the circle of the celestial equator Cc, an extension of the equator on the celestial sphere Cs, and the circle of the ecliptic Ce, the two circles being secant at the vernal point Pv. The arc of the circle between the star St and the celestial equator Cc along the hour circle Ch corresponds to the declination δ. The arc of the circle extending along the celestial equator Ce between the vernal point Pv and the hour circle Ch corresponds to the right ascension α.

The equatorial coordinates can thus be used to locate a star St on the celestial sphere, a virtual extension of the Earth to infinity. The right ascension α corresponds, in a certain sense, to the longitude L on this celestial sphere and has its origin at the vernal point Pv, the name given to one of the two points of intersection of the celestial equator plane Cc and the ecliptic plane Ce (the plane containing the apparent path of the Sun as seen from Earth) on the celestial sphere. The declination δ corresponds, in a certain sense, to the latitude on the celestial sphere, and has as its origin the celestial equator Cc.

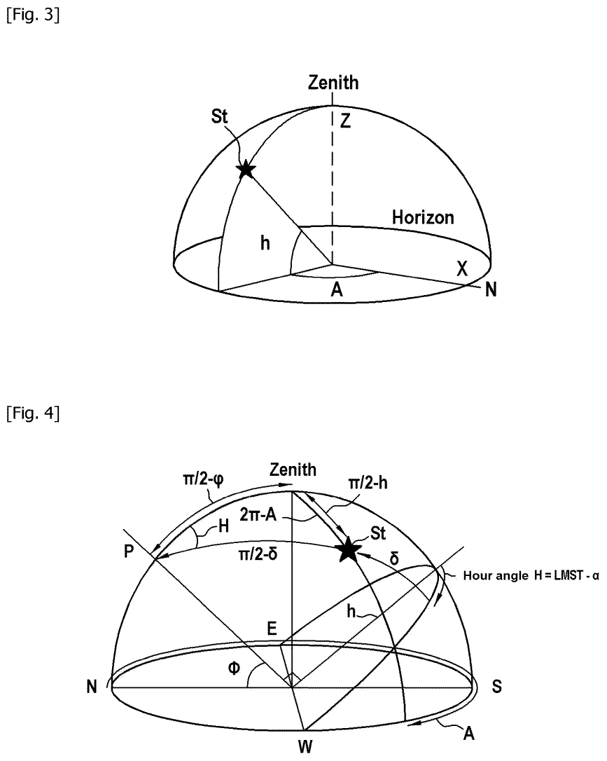

As shown in FIG. 3, the horizontal coordinates include the azimuth A and the height h, also known as the elevation.

They are used to measure the direction of an object in the sky, such as a star St, from a point on the Earth. The azimuth A is defined as the angle between true north N and the tracked object St. It is counted positively towards the East. The height h is defined as the angle between the tangent plane at the Earth's surface and the tracked object St. It is counted positively upwards. This coordinate system is also referred to as a local geographic reference frame, denoted [g]: the X-axis points North, the Z-axis points towards the zenith of the location (perpendicular to the plane tangent to the geoid) and the Y-axis forms a direct trihedron (not visible in this figure).

The transition from one coordinate system to another is based on geometric and temporal considerations.

FIG. 4 shows a diagram summarising the link between these three different coordinate systems and local apparent sidereal time, denoted LAST.

It can be seen in FIG. 4 that the connection is made by a spherical triangle “Star St-Zenith-Pole P”, and it is then sufficient to apply spherical trigonometry formulae in order to obtain the system S in the equation [Math 1] (see Umland's 2019 publication “A Short Guide to Celestial Navigation” for a demonstration example). Solving this variable system (L,φ) for a star located in the sky by (A,h) and with equatorial coordinates (α,δ) enables the position of the observer to be determined on the reference geoid. As a reminder, the system S of equations defined by [Math 1] is as follows:

$$S = \{ \begin{matrix}H = LAST - α = GAST + L - α \\ sin ( h ) = sin ( ϕ ) sin ( δ ) + cos ( ϕ ) cos ( δ ) cos ( H ) \\ cos ( A ) cos ( h ) = - cos ( H ) sin ( ϕ ) cos ( δ ) + sin ( δ ) cos ( ϕ ) \\ sin ( A ) cos ( h ) = - sin ( H ) cos ( δ ) \\ tan ( A ) = \frac{sin ( H )}{cos ( H ) sin ( ϕ ) - tan ( δ ) cos ( ϕ )}\end{matrix} \qquad [ Math 1 ]$$

with GAST designating Greenwich apparent sidereal time and LAST designating local apparent sidereal time.

The equatorial coordinates (α,δ) of a large number of stars are given by catalogues (or ephemerides) in a celestial reference frame, J 2000 for example, on a specific date called J 2000: the 1 Jan. 2000 at 12:00, Terrestrial Time. It should be noted that Terrestrial Time differs from Coordinated Universal Time (UTC) used in everyday life by a certain number of whole seconds called leap seconds, which change each year. The number of stars listed varies depending on the type of catalogue, and can be in the millions. The transition from the equatorial coordinates of a star on date J 2000 to another date and time of observation is made by physical corrections to the movement of the Earth (precession, nutation) and of the stars themselves (proper motion), which are described in detail in the article by Meeus, J. (1998) entitled “Astronomical Algorithms” published by Willmann-Bell. These physical corrections are not detailed here.

The University of Strasbourg database VizieR (https://vizier.cds.unistra.fr/viz-bin/VizieR) provides access to a number of catalogues.

The mean sidereal time at Greenwich at 00:00 Universal Time (UT), denoted GMST_0 in the system (S), is deduced using the following formula (a similar version of this formula, expressed in hour seconds, is given in the 1998 Meeus document already mentioned):

$${GMST}_{0} [ ° ] = 100 , 46061837 + 36000 , 770053608 T + 0 , 000387933 {T}^{2} - \frac{1}{38710000} {T}^{3} \qquad [ Math 7 ]$$

Where T is the number of Julian centuries that have elapsed since J 2000 (for a definition of Julian days, see the 1998 Meeus document already mentioned). From GMST₀ and UTC time, it is possible to deduce Greenwich sidereal time at UTC time t:

GMST [°]=GMST₀+1,00273790935t [Math 8]

From GMST, the Greenwich apparent sidereal time GAST is deduced:

GAST [°]=GMST+ε_{γ} [Math 9]

Where ε_{γ} denotes the equation for the equinoxes, for which a calculation method is given in the 1998 Meeus document already mentioned. Having the equatorial coordinates (α,δ) of the star to be observed and the Greenwich apparent sidereal time GAST, it remains to determine the azimuth and elevation (A,h) of the star from the observation site. To do this, a precise measurement means is required that can be used to obtain the horizontal coordinates (A,h).

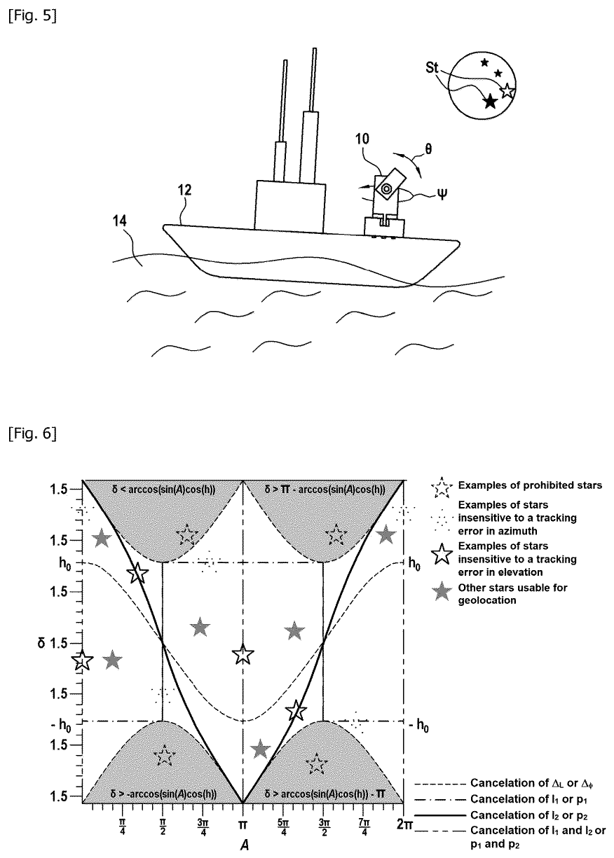

The method according to the invention proposes using a dual-axis tracker 10, i.e. a set of cameras mounted on a gimbal system that can be controlled along two axes θ and ψ, elevation and bearing, as illustrated in FIG. 5.

This tracker 10 is intended for use, for example, on a vessel 12 navigating on the open sea 14. The tracker 10 must include an inertial unit for estimating true north and the vertical of the observation location; the tracker can therefore be controlled in azimuth (A) and elevation (h). The inertial unit also enables the Line of Sight (i.e. the optical axis of a camera) to be inertially stabilised, so that the image returned by the camera is clear whatever the movements of the vessel.

However, not all stars are suitable for performing a geolocation function, and some are to be preferred.

In fact, there are singular locations and locations of insensitivity to tracker errors in azimuth and elevation for calculating the location. These singular and insensitivity locations are intrinsic to the system of equations [Math 1] and need to be supplemented with other precautions: tracking close to the horizon is not recommended because of atmospheric refraction (which is difficult to estimate), tracking close to the zenith is sometimes not possible depending on the type of tracking system used, etc.

In order to calculate the singular locations specific to the stellar tracking location problem, i.e. specific to the system of equations [Math 1], it is necessary to calculate the differentials of longitude L and latitude φ.

Let us assume that the equatorial coordinates (α,δ) can be considered constant with respect to the time scale considered (one day of observation). Then, it can be shown that the derivatives of the longitude L and latitude φ are written, for

$$h ∈ [ 0 , \frac{π}{2} ] , A ∈ [ 0 , 2 π ] , δ ∈ [ - \frac{π}{2} , \frac{π}{2} ] and H ∈ [ - \frac{π}{2} , \frac{π}{2} ]$$

(star visible from the observation location):

$$dL = \frac{{l}_{1} ( A , h )}{Δ L ( A , h , δ )} dA + \frac{{l}_{2} ( A , h )}{Δ L ( A , h , δ )} dh - dGAST \qquad [ Math 10 ]$$

$$d ϕ = \frac{{p}_{1} ( A , h , δ )}{Δϕ ( A , h , δ )} dA + \frac{{p}_{2} ( A , h , δ )}{Δϕ ( A , h , δ )} dh \qquad [ Math 11 ]$$

With l₁, l₂, p₁, p₂, ΔL, Δφ as defined above in equations [Math 3] to [Math 6].

This gives rise to singular locations ΔL=0 and ΔΦ=0, azimuth insensitivity locations l₁=0 and p₁=0, and elevation insensitivity locations l₂=0 and p₂=0. These locations are shown on the graph of FIG. 6.

The dotted curves in FIG. 6 then describe, in the parameter space traversed by (A,h,δ), unfavourable zones for locating stars using observation, the dotted stars representing examples of locating stars that are inaccessible to observation. The unfavourable zones correspond, firstly, to the grey areas delimited by the four dotted curves at the top and bottom of the graphical representation, and, secondly, to the dotted curve passing through and oscillating in h₀ and −h₀ ranging from 0 to 2π in azimuth A.

By contrast, the solid line curve and the dot-dash line curve describe zones to be favoured for this same objective. The solid line curve represents a zone in which the location is insensitive to an error in elevation h, and the dot-dash line curve represents a zone in which the location is insensitive to an error in azimuth A.

The solid line curve for the insensitivity of the location to an elevation error h is defined by the following equation:

δ=sign(sin(A))arctan(1/(cos(h)tan(A))) [Math 12]

The mixed line curve for the insensitivity of the location to an azimuth error h is defined by the following equation:

δ=sign(−cos(A))h [Math 13]

In addition, at the location points A=π, there is a double insensitivity of the location to both an error in elevation h and to an error in azimuth A, as illustrated by the vertical lines (one long line and two dots).

In addition, in the graphical representation, dotted stars represent examples of stars that are insensitive to a tracking error in azimuth A, solid stars represent examples of stars that are insensitive to a tracking error in elevation h, and solid (greyed-out) stars represent examples of stars that can be used for geolocation.

In addition, it is possible to obtain analytical expressions for these curves and to use them to discriminate between stars in real time during observations, thus ensuring the convergence and optimality of the position estimation performed.

From a practical point of view, the position and attitude of the system are estimated using the inertial unit: this is a discrete signal, sampled at a frequency fₑ (generally 100 Hz), and therefore updated regularly. The tracked star can then be used to refine or correct this estimate.

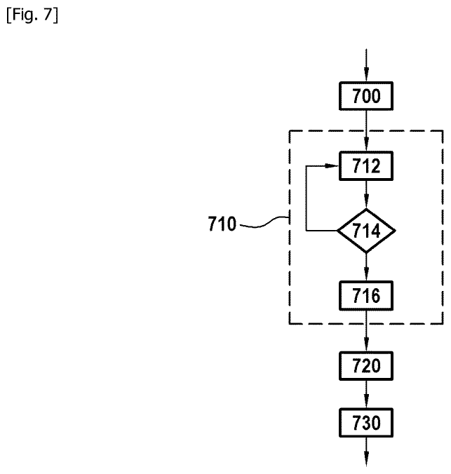

The flow diagram in FIG. 7 shows a flow diagram of a process for selecting observable stars to be used according to an embodiment of the invention for use in a method for correcting the drift in a navigation device.

Let fₑ be the sampling frequency of the inertial unit. In the star selection process, the following steps are carried out.

At UTC time t₀, the position estimated by the inertial unit is saved, (L₀, φ₀).

Using a star catalogue and UTC time UTC to, the algorithm calculates the set of observable stars from (L₀, φ₀) using the system of equations [Math 1].

The algorithm then chooses M observable stars (for example, M=10 in order to have enough stars for statistical processing), eliminating those with too low a height h<h_{inf} for example, h<45° to avoid problems of atmospheric refraction) and those too close to singular locations ΔL=0 and Δφ=0 and favouring those close to insensitivity locations l₁=0, p₁=0, l₂=0 or p₂=0. This choice is made by calculating the parameter

$${X}_{i} := {( \frac{{l}_{1}}{{Δ}_{L}} )}^{2} + {( \frac{{l}_{2}}{{Δ}_{L}} )}^{2} + {( \frac{{p}_{1}}{{Δ}_{ϕ}} )}^{2} + {( \frac{{p}_{1}}{{Δ}_{ϕ}} )}^{2} , \qquad [ Math 2 ]$$

which serves as an indicator.

More explicitly, the stars are selected from stars listed in a catalogue where each star is associated with equatorial coordinates at a specific date called J 2000, the equatorial coordinates comprising a right ascension, α, and a declination, δ.

The star selection method comprises, in a first step 700, the navigation device determining the geographical coordinates of a star tracker at a start time, the geographical coordinates of the star tracker comprising a longitude, L, and a latitude, φ.

Then, in a second step 710, background processing is performed for each star in the catalogue. The background processing for each star comprises the following sub-steps.

Calculating 712 the tracking coordinates of the star, comprising a calculation, using the system of equations [Math 1], of the horizontal coordinates of the star from the equatorial coordinates of the star and the geographical position of the tracker, the equatorial coordinates comprising an azimuth, A, of the star and an elevation, h, of the star.

Determining the accessibility of the star from the calculated tracking coordinates, the accessibility determination comprising comparing 714 the calculated elevation for the star with a minimum elevation threshold, the star being inaccessible if its calculated elevation is less than the minimum elevation threshold.

And, if the star is accessible, calculating 716 an observation sensitivity parameter of the star, the tracking coordinates of the star corresponding to the horizontal coordinates of the star relative to the geographical position of the star tracker, the horizontal coordinates comprising an azimuth, A, and an elevation, h.

Then in a third step 720, the tracking coordinates and observation sensitivity parameter calculated for each star are stored, and the stars thus stored are classified in ascending order of sensitivity parameter of the star, the stars for which the sensitivity parameter is zero being excluded from the classification.

Finally, in a fourth step 730, a given number of observable stars are selected, the stars being selected according to the order of classification of the stored stars.

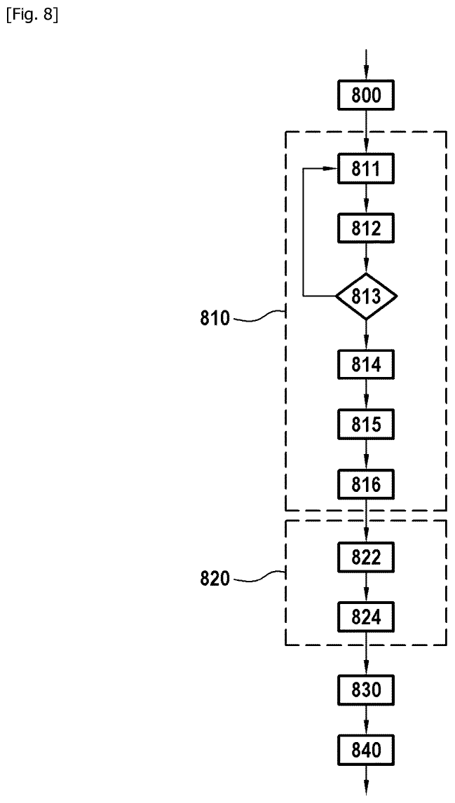

In order to achieve reliable geolocation, for example on a vessel at sea, and therefore to avoid drift in the navigation device, the invention proposes using the drift correction method illustrated in the flow diagram of FIG. 8.

The method for correcting drift in a navigation device for a vehicle using a star tracking geolocation means shown in the flow chart of FIG. 8 firstly comprises a step of preselecting stars, comprising an initial step 800 of selecting stars to be used by the star tracking geolocation device based on the method for selecting observable stars to be used in the method illustrated in FIG. 7.

The correction method then comprises a subsequent step 810 of measurements comprising, firstly, the navigation device determining the geographical coordinates of the star tracker, the geographical coordinates of the star tracker comprising a longitude L and a latitude o, then, for each of the selected stars, checking the accessibility of the star and measuring the horizontal coordinates of the star, the measured horizontal coordinates being recorded in association with the corresponding equatorial coordinates for the star and the time of measurement.

The measurements step 810 comprises calculating 811 the horizontal coordinates of the selected star from the time of calculating, the geographical coordinates of the star tracker at the time of calculating, and the equatorial coordinates indicated in a catalogue where each star is associated with equatorial coordinates on a specific date, the equatorial coordinates comprising a right ascension (α) and a declination (δ) and the horizontal coordinates comprising an azimuth (A) and an elevation h. The method then comprises orienting 812 a star tracker according to the calculated horizontal coordinates, and verifying 813 the accessibility of the selected star.

If the selected star is inaccessible, it comprises repeating the three previous steps with a new star from the star selection, whereas if the star is accessible, it comprises repositioning 814 the selected star at the centre of the star tracker, the navigation device measuring 815 for 5 seconds, the horizontal coordinates of the star tracked by the star tracker after repositioning, and recording 816 the time of measurement, the thus measured repositioned horizontal coordinates, the associated equatorial coordinates and the geographical coordinates of the tracker at the time of measurement.

The correction method then comprises a subsequent processing step 820 comprising, for all the stars for which measured horizontal coordinates have been recorded, calculating 822 the geographical coordinates of the star tracker from the measured horizontal coordinates recorded for the star, the recorded time of measurement, the recorded equatorial coordinates and the system of equations [Math 1], and estimating 824 the error between the calculated geographical coordinates and the geographical coordinates determined by the navigation device during the tracking of the star.

It then comprises a subsequent step 830 of estimating the drift error in the navigation device from the estimated errors in the geographical coordinates.

Finally, it comprises a step 840 of correcting the drift in the navigation device using the estimated drift error.

In other words, if the chosen star is taken from the N preselected stars, t is the UTC time sampled at fₑ, and (Lᵢ(t), φᵢ(t)) the position estimate returned by the inertial unit and/or the satellite navigation system of the navigation device, i.e. a signal sampled at fₑ.

Dynamically, i.e. at each sampling period, the method precisely calculates (Aᵢ(t), hᵢ(t)) of the star Stᵢ using the catalogue giving the equatorial coordinates (αᵢ(t), δᵢ(t)) of Stᵢ at UTC time t, (Lᵢ(t), φᵢ(t)) and the system of equations [Math 1].

If (Aᵢ(t), hᵢ(t)) is too close to a singularity, then the star Stᵢ is ignored and the following star is taken.

Otherwise the tracker is pointed in the direction (Aᵢ(t), hᵢ(t)) and, if the star is not visible, then it is ignored and the following star is taken. Otherwise, a measurement ( [symbol] (t), [symbol] (t)) is made in the local geographic reference frame, using the inertial unit, i.e. the actual position of the star in the sky at time t (different from (Aᵢ(t), hᵢ(t)). This measurement is carried out for 5 seconds.

The signals ( [symbol] (t), [symbol] (t)), (αᵢ(t),δᵢ(t)), (Lᵢ(t),φᵢ(t)) and the universal time, UTC, are saved during the 5 seconds of observation.

Following the measurement sequence, for each star measured Eᵢ, the signal is calculated ( [symbol] (t), [symbol] (t)) by solving the system of equations [Math 1] using the UTC time of the measurement, ( [symbol] (t), [symbol] (t)) and (αᵢ(t), δᵢ(t)).

The error between the position returned by the navigation device and the position estimated by star tracking is then calculated:

(ϵ_{Li}(t),ϵ_{φi}(t))=(Lᵢ(t)− [symbol] (t),φᵢ(t)− [symbol] (t)) [Math 14]

This error represents an estimate of the position error of the unit. The latter must have a slow dynamic range, and therefore a zero slope over the measurement range (5 seconds). Averaging this signal returns an estimate of the position error in the unit for star tracking number i.

The averages (M_{L}_{ᵢ}, M_{φ}_{ᵢ}) and the standard deviations (σ_{L}_{ᵢ}, σ_{φ}_{ᵢ}) of each of these signals are saved. An average-exclusion over the N measurements is then used to obtain a correct estimate of the position error in the unit.

1. A method for selecting observable stars to use for a geolocation by a vehicle, in particular a vessel at sea, on the basis of a star tracking geolocation means associated with at least one navigation device, the stars being selected from stars listed in a catalogue where each star is associated with equatorial coordinates on a specific date, the equatorial coordinates comprising a right ascension and a declination,
the method comprising:
determining the geographical coordinates of a star tracker at a start time by the navigation device, the geographical coordinates of the star tracker comprising a longitude and a latitude, then
for each star of the catalogue, calculating the tracking coordinates of the star, determining the accessibility of the star from the calculated tracking coordinates, and, if the star is accessible, calculating an observation sensitivity parameter of the star, the tracking coordinates of the star corresponding to the horizontal coordinates of the star relative to the geographical position of the star tracker, the horizontal coordinates comprising an azimuth and an elevation, then
storing the tracking coordinates and observation sensitivity parameter calculated for each star, and classifying the stars thus stored in ascending order of sensitivity parameter of the star, the stars for which the sensitivity parameter is zero being excluded from the classification, and
selecting a given number of observable stars, the stars being selected according to the order of classification of the stored stars.

2. The method for selecting observable stars according to claim 1, wherein calculating the tracking coordinates of each star comprises calculating the horizontal coordinates of the star from equatorial coordinates of the star and the geographical position of the tracker, the equatorial coordinates comprising an azimuth of the star and an elevation of the star, and
wherein determining the accessibility of the star comprises comparing the calculated elevation of the star with a minimum elevation threshold, the star being inaccessible if its calculated elevation is less than the minimum elevation threshold.

3. The method for selecting observable stars according to claim 2, wherein the geographical coordinates of the tracker used for calculating the horizontal coordinates of the star depend on the time at which the calculation is performed, the geographical coordinates of the tracker being estimated at each time from geographical coordinates of the tracker determined at the start time and a calculation taking account of the heading and speed of the vehicle at the time of the determination.

4. The method for selecting observable stars according to claim 2, wherein the calculating of the tracking coordinates of the star from geographical coordinates of the star tracker and the equatorial coordinates of the star considered is performed using the system of equations:
$$S = \{ \begin{matrix}H = LAST - α = GAST + L - α \\ sin ( h ) = sin ( ϕ ) sin ( δ ) + cos ( ϕ ) cos ( δ ) cos ( H ) \\ cos ( A ) cos ( h ) = - cos ( H ) sin ( ϕ ) cos ( δ ) + sin ( δ ) cos ( ϕ ) \\ sin ( A ) cos ( h ) = - sin ( H ) cos ( δ ) \\ tan ( A ) = \frac{sin ( H )}{cos ( H ) sin ( ϕ ) - tan ( δ ) cos ( ϕ )}\end{matrix} \qquad [ Math 1 ]$$
with GAST designating the Greenwich apparent sidereal time and LAST designating the local apparent sidereal time.

5. The method for selecting observable stars according to claim 1, wherein the calculated observation sensitivity parameter of the star depends solely on the azimuth, elevation and declination of the star considered.

6. The method for selecting observable stars according to claim 5, wherein the observation sensitivity parameter of the star is calculated via the equation:
$${X}_{i} = {( \frac{{l}_{1}}{{Δ}_{L}} )}^{2} + {( \frac{{l}_{2}}{{Δ}_{L}} )}^{2} + {( \frac{{p}_{1}}{{Δ}_{ϕ}} )}^{2} + {( \frac{{p}_{1}}{{Δ}_{ϕ}} )}^{2} \qquad [ Math 2 ]$$
$$with {l}_{1} = cos ( A ) cos ( h ) , {l}_{2} = - sin ( A ) sin ( h ) , \\ {Δ}_{L} = \sqrt{{cos ( δ )}^{2} - {sin ( A )}^{2} {cos ( h )}^{2}} , \qquad [ Math 3 ]$$
$${p}_{1} = cos ( h ) sin ( A ) ( ( {sin ( h )}^{2} - {cos ( h )}^{2} {cos ( A )}^{2} ) sin ( δ ) \sqrt{{cos ( δ )}^{2} - {sin ( A )}^{2} {cos ( h )}^{2}} - cos ( h ) sin ( h ) cos ( A ) ( {cos ( δ )}^{2} - {sin ( A )}^{2} {cos ( h )}^{2} - {sin ( δ )}^{2} ) ) , \qquad [ Math 4 ]$$
$${p}_{2} = ( 1 + {sin ( A )}^{2} {cos ( h )}^{2} ) sin ( h ) cos ( A ) sin ( δ ) \sqrt{{cos ( δ )}^{2} - {sin ( A )}^{2} {cos ( h )}^{2}} - cos ( h ) ( {sin ( δ )}^{2} {sin ( A )}^{2} {sin ( h )}^{2} + {cos ( A )}^{2} ( {cos ( δ )}^{2} - {sin ( A )}^{2} {cos ( h )}^{2} ) ) , and \qquad [ Math 5 ]$$
$${Δ}_{ϕ} = \sqrt{{cos ( δ )}^{2} - {sin ( A )}^{2} {cos ( h )}^{2}} ( 1 - {sin ( A )}^{2} {cos ( h )}^{2} ) \vert cos ( A ) cos ( h ) \sqrt{{cos ( δ )}^{2} - {sin ( A )}^{2} {cos ( h )}^{2}} - sin ( δ ) sin ( h ) \vert , \qquad [ Math 6 ]$$
$$with h ∈ [ 0 , \frac{π}{2} ] , A ∈ [ 0 , 2 π ] , δ ∈ [ - \frac{π}{2} , \frac{π}{2} ] and H ∈ [ - \frac{π}{2} , \frac{π}{2} ] .$$

7. A method for correcting drift in a navigation device for a vehicle using a star tracking geolocation means, the correction method comprising:
a step of preselecting stars comprising a selection of stars to be used by the star tracking geolocation device using the method for selecting observable stars to be used according to claim 1, then
a step of measurements comprising, firstly, the navigation device determining the geographical coordinates of the star tracker, the geographical coordinates of the star tracker comprising a longitude and a latitude, then, for each of the selected stars, checking the accessibility of the star and measuring the horizontal coordinates of the star, the measured horizontal coordinates being recorded in association with the corresponding equatorial coordinates for the star and the time of measurement, then
a processing step comprising, for all the stars for which the measured horizontal coordinates have been recorded:
calculating geographical coordinates of the star tracker using the measured horizontal coordinates recorded for the star, the recorded time of measurement, the recorded equatorial coordinates and the system of equations:
$$S = \{ \begin{matrix}H = LAST - α = GAST + L - α \\ sin ( h ) = sin ( ϕ ) sin ( δ ) + cos ( ϕ ) cos ( δ ) cos ( H ) \\ cos ( A ) cos ( h ) = - cos ( H ) sin ( ϕ ) cos ( δ ) + sin ( δ ) cos ( ϕ ) \\ sin ( A ) cos ( h ) = - sin ( H ) cos ( δ ) \\ tan ( A ) = \frac{sin ( H )}{cos ( H ) sin ( ϕ ) - tan ( δ ) cos ( ϕ )}\end{matrix} \qquad [ Math 1 ]$$
with GAST designating the Greenwich apparent sidereal time and LAST designating the local apparent sidereal time.
estimating the error between the calculated geographical coordinates and the geographical coordinates determined by the navigation device during the tracking of the star, then
a step of estimating the drift error in the navigation device from estimated errors in the geographical coordinates, and
a step of correcting the drift in the navigation device from the estimated drift error.

8. The method for correcting drift in a navigation device for a vehicle according to claim 7, wherein the measurements step comprises:
calculating the horizontal coordinates of the selected star using the time of calculating, the geographical coordinates of the star tracker at the time of calculating, and the equatorial coordinates indicated in a catalogue where each star is associated with equatorial coordinates on a specific date, the equatorial coordinates comprising a right ascension and a declination and the horizontal coordinates comprising an azimuth and an elevation, then
orienting a star tracker according to the calculated horizontal coordinates,
checking the accessibility of the selected star,
if the selected star is inaccessible, repeating the preceding three steps with a new star from the selection of stars,
if the star is accessible, repositioning the selected star at the centre of the star tracker, measurement by the navigation device of the horizontal coordinates of the star tracked by the star tracker after repositioning, and recording the time of measurement, the thus measured repositioned horizontal coordinates, the associated equatorial coordinates and geographical coordinates of the tracker at the time of measurement.

9. The method for correcting drift in a navigation device for a vehicle according to claim 7, wherein the measurement by the navigation device of the horizontal coordinates of the star tracked by the star tracker after repositioning is performed for 5 seconds.

10. The method for correcting drift in a navigation device for a vehicle according to claim 7, wherein the navigation device comprises a satellite positioning system.
